(19) United States
(12) Patent Application Publication
(10) Pub. No.: US 2018/0122555 A1
(43) Pub. Date: May 3, 2018

(54) MULTILAYER ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Ki Seok KIM, Suwon-si (KR); Ye Jeong KIM, Suwon-si (KR); Tae Hong MIN, Suwon-si (KR); Myung Sam KANG, Suwon-si (KR); Kwang Hee KWON, Suwon-si (KR)

(21) Appl. No.: 15/655,655

(22) Filed: Jul. 20, 2017

(30) Foreign Application Priority Data
Oct. 27, 2016 (KR) 10-2016-0141328

(51) Int. Cl. H01F 27/28; H01F 41/04

(52) U.S. Cl. CPC H01F 27/2804; H01F 2027/2809; H01F 41/043

(57) ABSTRACT

Embodiments disclosed are directed to a multilayer electronic component and a method of manufacturing the same. The multilayer electronic component may includ a multilayer body having a plurality of insulating layers and internal coil parts disposed on the insulating layers. The plurality of insulating layers and internal coil parts are stacked. The multilayer electronic component may also include and external electrodes disposed on external surfaces of the multilayer body and connected to the internal coil parts. The internal coil parts include a first metal and a second metal having electrical conductivity higher than that of a first metal is disposed on the internal coil parts and surrounds the internal coil parts.

### CROSS-REFERENCE TO RELATED APPLICATION

This application claims priority under 35 U.S.C. § 119 to Korean Patent Application No. 10-2016-0141328 filed on Oct. 27, 2016, in the Korean Intellectual Property Office (KIPO), the disclosure of which is incorporated herein by reference in its entirety.

### BACKGROUND

### 1. Field

The present disclosure relates to a multilayer electronic component and a method of manufacturing the same.

### 2. Description of Related Art

An inductor, an electronic component, is a representative passive element constituting an electronic circuit, together with a resistor and a capacitor, to reduce noise in the electronic circuit. Such an inductor is combined with a capacitor using electromagnetic properties thereof to constitute a resonance circuit amplifying a signal in a specific frequency band, a filter circuit, or the like.

Ina multilayer inductor, coil patterns are formed using a conductive paste, or the like, on insulating sheets using a magnetic material as a main material, and the insulating sheets on which the coil patterns are formed are stacked to form a coil in a stacked sintered body, thereby implementing inductance.

A vertical multilayer inductor in the related art includes an internal coil formed in a direction perpendicular to a board mounting surface in order to implement a higher degree of inductance. The vertical multilayer inductor may have an inductance value higher than that of a multilayer inductor in which the internal coil is formed in a horizontal direction, and may have a higher magnetic resonance frequency.

Recently, there has been research into a method of manufacturing a multilayer inductor using a collective stacking method by adopting a method using conductive bumps rather than an existing method using copper plating.

In a high frequency inductor having an open magnetic path using a dielectric, an equivalent series resistance in a high frequency region is increased due to loss of magnetic flux and parasitic capacitance generated between internal metals or between the internal metals and external metals, and this causes in deterioration of a quality (Q) factor.

When parasitic capacitance generated between the internal metals or between the internal metals and the external metals is reduced in order to reduce the equivalent series resistance Rs and the loss of the magnetic flux is reduced and an inductance value increases, thereby improving the Q factor.

### SUMMARY

An aspect of the present disclosure may provide a multilayer electronic component of which a quality (Q) factor may be improved by reducing a skin effect and a parasitic effect to reduce equivalent series resistance Rs, and a method of manufacturing the same.

According to an aspect of the present disclosure, a multilayer electronic component may include a multilayer body having a plurality of insulating layers and internal coil parts disposed on the insulating layers. The plurality of insulating layers may be stacked. The multilayer electronic component may also include external electrodes disposed on external surfaces of the multilayer body and connected to the internal coil parts . The internal coil parts may include a first metal and a second metal having an electrical conductivity higher than that of a first metal is disposed on the internal coil parts and surrounds the internal coil parts.

According to another aspect of the present disclosure, a method of manufacturing a multilayer electronic component may include preparing a plurality of insulating sheets, forming internal coil patterns on the insulating sheets, applying a first metal to surround the internal coil patterns, the first metal having electrical conductivity higher than that of a second metal included in the internal coil patterns, forming a multilayer body including internal coil parts by stacking the insulating sheets on which the internal coil patterns are formed, and forming external electrodes on external surfaces of the multilayer body. The external electrodes are connected to the internal coil parts.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view of a multilayer electronic component according to an exemplary embodiment illustrating the internal coil parts thereof.

FIG. 2 is an elevation view taken in direction A of FIG. 1.

FIG. 3 is a cross-sectional view taken along line I-I′ of FIG. 2.

FIG. 4 is a flow chart illustrating a method of manufacturing a multilayer electronic component according to an exemplary embodiment.

### DETAILED DESCRIPTION

Hereinafter, exemplary embodiments of the present disclosure will now be described in detail with reference to the accompanying drawings.

Multilayer Electronic Component

Hereinafter, a multilayer electronic component according to an exemplary embodiment of the present disclosure, particularly, a multilayer inductor will be described. However, the multilayer electronic component is not limited thereto.

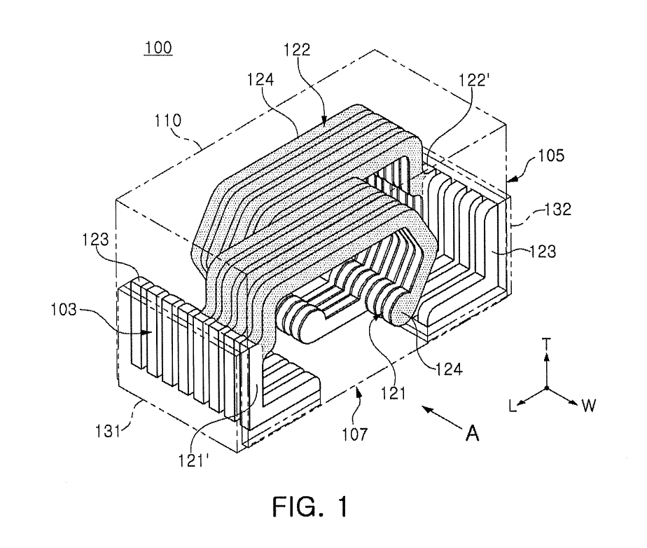

FIG. 1 is a schematic perspective view of a multilayer electronic component 100 according to an exemplary embodiment depicting the internal coil parts of the multilayer electronic component.

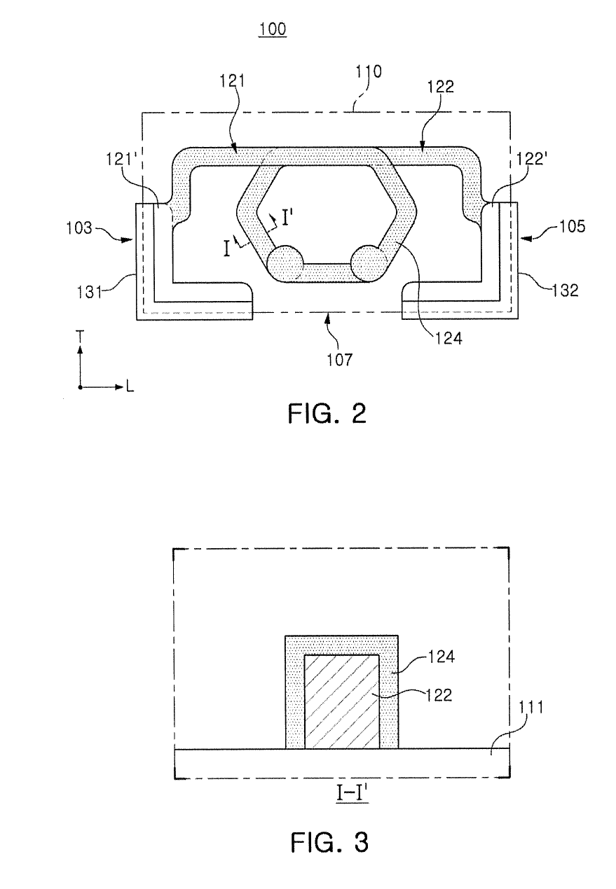

FIG. 2 is an elevation view taken in direction A of FIG. 1.

FIG. 3 is a cross-sectional view taken along line I-I′ of FIG. 2.

Referring to FIGS. 1 through 3, a multilayer electronic component 100 according to an exemplary embodiment may include a multilayer body 110, internal coil parts 121 and 122, and first and second external electrodes 131 and 132.

The multilayer body 110 may be formed by stacking a plurality of insulating layers, and the plurality of insulating layers forming the multilayer body 110 may be in a sintered state, and adjacent insulating layers may be integrated with each other so that boundaries therebetween are not readily apparent without the use of a magnifying instruments, for example, a scanning electron microscope (SEM) or the like.

The multilayer body 110 may have a hexahedral shape. Directions of a hexahedron will be defined in order to clearly describe an exemplary embodiment. L, W and T illustrated in FIG. 1 refer to a length direction, a width direction, and a thickness direction, respectively.

The multilayer body 110 may be or include ferrite such as Mn—Zn-based ferrite, Ni—Zn-based ferrite, Ni—Zn—Cu-based ferrite, Mn—Mg-based ferrite, Ba-based ferrite, Li-based ferrite, a combination thereof and the like.

According to the exemplary embodiment, an insulating material included in the multilayer body 110 may include a material having dielectric properties lower than those of a photosensitive material.

The internal coil parts 121 and 122 may be formed by printing a conductive paste, including a first metal having conductivity, to a predetermined thickness on the plurality of insulating layers forming the multilayer body 110.

The first metal forming the internal coil parts 121 and 122 is not limited to any particular metal and any desired metal having a desired electrical conductivity may be used. For example, the first metal may be or include palladium (Pd), aluminum (Al), nickel (Ni), titanium (Ti), gold (Au), copper (Cu), platinum (Pt), a mixture thereof and the like.

In an example, the internal coil parts 121 and 122 may be or include copper (Cu).

Vias may be formed in predetermined positions on each of the insulating layers on which the internal coil parts 121 and 122 are formed, and the internal coil parts 121 and 122 formed on each of the insulating layers may be electrically connected to each other through the vias to form one coil.

In this case, the plurality of insulating layers on which the internal coil parts 121 and 122 are formed are stacked in the width direction W of the multilayer body 110, such that the internal coil parts 121 and 122 may be disposed in a direction perpendicular to a board mounting surface (e.g., the bottom surface in FIG. 1) of the multilayer body 110.

The internal coil parts 121 and 122 may include first internal coil parts 121 exposed to end surface 103 of the multilayer body 110 in the length direction L and second internal coil parts 122 exposed to end surface 105 of the multilayer body 110 opposite the end surface 103 in the length direction L. As illustrated, the end surfaces 103 and 105 are perpendicular to surfaces of the stacked insulating layers.

The first internal coil parts 121 may include first lead portions 121′ exposed to the end surface 103 of the multilayer body 110, and the second internal coil parts 122 may include second lead portions 122′ exposed to the end surface 105 of the multilayer body 110.

In addition, the first lead portions 121′ and the second lead portions 122′ may also be exposed to a lower or bottom surface 107 of the multilayer body 110. In an example, the bottom surface 107 may be the board mounting surface of the multilayer body 110.

As illustrated, the first lead portions 121′ and the second lead portions 122′ may have an ‘L’ shape in a cross section of the multilayer body 110 in a length-thickness direction.

The multilayer electronic component 100 according to the exemplary embodiment may include the first external electrode 131 disposed on end surface 103 of the multilayer body 110 in the length direction L and the bottom surface 107 of the multilayer body 110 and connected to the first lead portions 121′ and the second external electrode 132 disposed on the end surface 105 of the multilayer body 110 in the length direction L and the bottom surface 107 of the multilayer body 110 and connected to the second lead portions 122′.

The first external electrode 131 and the second external electrode 132 may be formed on the bottom surface 107 of the multilayer body 110 and the end surfaces 103 and 105 of the multilayer body 110 and may be electrically connected to the first lead portions 121′ and the second lead portions 122′ of the internal coil parts 121 and 122, respectively.

Each of the first external electrode 131 and the second external electrode 132 may be or include metal that may be plated. For example, the first external electrode 131 and the second external electrode 132 may be or include nickel (Ni), tin (Sn), mixture thereof, and the like.

Referring to FIG. 3, in the multilayer electronic component 100 according to the exemplary embodiment, a second metal 124 having electrical conductivity higher than that of the first metal constituting the internal coil parts 121 and 122 may be disposed to surround the internal coil parts 121 and 122.

In an existing multilayer inductor, external electrodes are formed on both the opposite end surfaces of a multilayer body in a length direction and on portions of surfaces of the multilayer body adjacent to the end surfaces by a dipping method using a conductive paste. In such a multilayer inductor, a magnetic flux by an induced current of a conductor is blocked, and this results in deterioration of a quality (Q) factor.

Generally, in an inductor in which internal coil parts are stacked vertically to a mounting surface of a board, when external electrodes are formed on both opposite end surfaces of a multilayer body in a length direction, an eddy current is generated in the external electrodes and loss due to the generation of the eddy current is increased. This generates a parasitic capacitance between the internal coil parts and the external electrodes, and the parasitic capacitance causes a reduction in a magnetic resonant frequency of the inductor.

Therefore, in the inductor in which the internal coil parts are stacked vertically to the mounting surface of the board, the external electrodes are formed on only the bottom surface of the multilayer body that faces the board (e.g., printed circuit board (PCB)) when the inductor is mounted thereon or on only end surfaces of the multilayer body in the length direction and the lower surface of the multilayer body so that the chip element including the inductor may be miniaturized and loss due to the generation of the eddy current may be minimized.

In a high frequency inductor, which has an open magnetic path using a dielectric, equivalent series resistance in a high frequency region is increased due to loss of magnetic flux and parasitic capacitance generated between internal metals or between the internal metals and external metals, resulting in deterioration of a quality (Q) factor.

The equivalent series resistance is represented by the sum of a direct current (DC) resistance constant regardless of a change in a frequency and an alternating current (AC) resistance at which a magnitude and a value are changed in accordance with a change in an AC frequency.

Due to a skin effect and a parasitic effect depending on an increase in the AC frequency, the AC resistance increases, and equivalent series resistance (Rs) increases.

The equivalent series resistance (Rs) increases due to the parasitic effect and due to an increase in parasitic capacitance as a distance between layers of a coil and a distance between the coil and an external electrode are reduced. The equivalent series resistance (Rs) also increases as a frequency is increased due to the skin effect. All these factors result in a reduction of a quality (Q) factor.

According to the exemplary embodiment in the present disclosure, disposing the second metal 124 having the electrical conductivity higher than that of the first metal constituting the internal coil parts 121 and 122 on the internal coil parts 121 and 122 and to surround the internal coil parts 121 and 122 may result in an improvement of a quality (Q) factor.

The second metal 124 may be disposed to surround regions of the first and second coil parts 121 and 122 that provide an inductive effect, and may not surround the first lead portions 121′ and the second lead portions 122′.

The first lead portions 121′ and the second lead portions 122′ may thus only be formed of copper (Cu), the first metal constituting the internal coil parts 121 and 122.

Therefore, a quality (Q) factor of the multilayer electronic component 100 according to the exemplary embodiment may be improved.

The second metal 124 having the high electrical conductivity may be coated on the coil on which a magnetic flux and a current are concentrated due to the skin effect and the parasitic effect to reduce a saturation state of a current and a magnetic flux in portions in which the current is concentrated at a high frequency. As a result, an AC resistance may be reduced, and a multilayer electronic component 100 having an improved quality (Q) factor may be obtained.

The second metal 124 having the electrical conductivity higher than that of the first metal constituting the internal coil parts 121 and 122 may include silver (Ag), but is not limited thereto. The second metal 124 may include any metal having electrical conductivity higher than that of the first metal constituting the internal coil parts 121 and 122.

In an example, when the coil is formed of copper (Cu), the second metal 124 maybe or include silver (Ag) and internal coil parts 121 and 122 may be or include copper (Cu).

According to the exemplary embodiment in the present disclosure, the multilayer body 110 may further include dummy lead portions 123 disposed on a plurality of insulating layers and externally exposed.

The dummy lead portions 123 may be included in the multilayer body 110 by forming patterns having shapes similar to those of the first lead portions 121′ and the second lead portions 122′ on the plurality of insulating layers.

The plurality of insulating layers on which the internal coil parts 121 and 122, the first lead portions 121′, and the second lead portion 122′ are formed and the plurality of insulating layers on which the dummy lead portions 123 are formed may be stacked adjacently to each other to form the multilayer body 110 according to the exemplary embodiment.

The plurality of insulating layers on which the dummy lead portions 123 are formed are stacked adjacent the plurality of insulating layers on which the internal coil parts 121 and 122, the first lead portions 121′, and the second lead portion 122′ are formed, such that an increased number of metallic bonds may be generated between the multilayer body 110 and the external electrodes 131 and 132 disposed on the end surfaces of the multilayer body 110 in the length direction and the bottom surface 107 of the multilayer body 110. This may result in improvement of adhesion between the internal coil parts and the external electrodes and adhesion between the multilayer electronic component and a printed circuit board.

According to the exemplary embodiment in the present disclosure, an insulating material included in the multilayer body 110 may include a material having dielectric properties lower than those of a photosensitive material.

According to the exemplary embodiment in the present disclosure, the insulating material having the dielectric properties lower than that of the photosensitive material may be used to reduce the skin effect, resulting in improved electrical, mechanical, and thermal characteristics.

The insulating material is not limited to any particular material, and may include, for example, a liquid crystal polymer (LCP) film, an LCP film including an inorganic filler, or a low dissipation factor (Df) epoxy-based insulating material.

Method of Manufacturing Multilayer Electronic Component

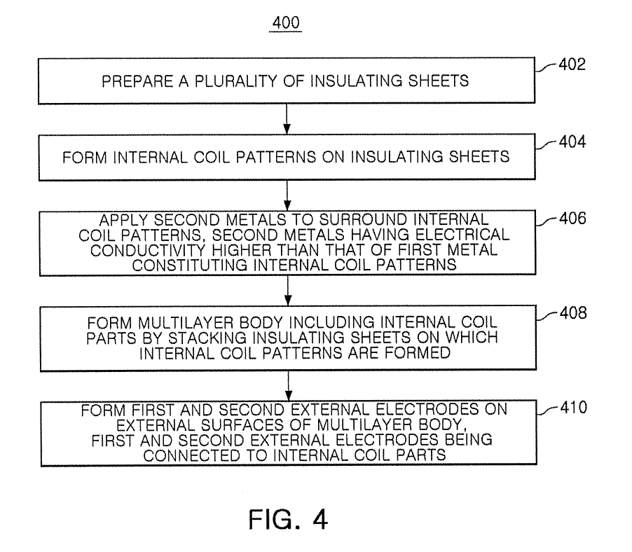

FIG. 4 is a flow chart illustrating a method 400of manufacturing a multilayer electronic component according to an exemplary embodiment.

The method 400 of manufacturing a multilayer electronic component may include preparing a plurality of insulating sheets, as at 402, forming internal coil patterns on the insulating sheets, as at 404, applying second metal to surround the internal coil patterns, the second metal having electrical conductivity higher than that of a first metal constituting the internal coil patterns, as at 406, forming a multilayer body including internal coil parts by stacking the insulating sheets on which the internal coil patterns are formed, as at 408, and forming external electrodes on external surfaces of the multilayer body, the external electrodes being connected to the internal coil parts, as at 410.

Referring to FIG. 4, at 402, the plurality of insulating sheets may first be prepared.

A magnetic material used to manufacture the insulator sheet is not limited to any particular material, but may be or include, for example, a ferrite powder such as a Mn—Zn-based ferrite powder, a Ni—Zn-based ferrite powder, a Ni—Zn—Cu-based ferrite powder, a Mn—Mg-based ferrite powder, a Ba-based ferrite powder, a Li-based ferrite powder, a combination thereof, and the like.

The insulating sheets may be manufactured by laminating dielectric films in a semi-hardened state on carrier films.

The carrier films, which are resin films that permit easy relatively handling of the dielectric films during manufacture and that protect the dielectric film, may be attached to opposite surfaces of the dielectric film.

The carrier film may be a material including a resin such as polyethylene terephthalate (PET), polyethylene-naphthalate (PEN), polycarbonate (PC), or the like, and having a thickness of about 10 to about 200 μm.

In an exemplary embodiment, a PET carrier film having a thickness of 50 μm may be used.

The carrier film may be needed to be detached with relative ease in a removal process while having relatively good adhesion strength.

To this end, a high temperature foaming type adhesive, an ultraviolet (UV) curable adhesive, or the like, may be used to adjust attachment and detachment of the carrier film.

In the present exemplary embodiment, the high temperature foaming type adhesive of which adhesion is lost when it is heated to about 100° C. was used to adhere the carrier film and the dielectric film to each other.

The dielectric film may be or include a thermosetting resin having a semi-hardened state.

In the present exemplary embodiment, an LCP film, an LCP film including an inorganic filler, or a low dissipation factor (Df) epoxy-based insulating material was used. In a laminating process, the dielectric film may be in the semi-hardened state. In order to implement the semi-hardened state, a thermosetting resin may be used or a material having both ultraviolet (UV) curable and heat curable mechanisms may be used.

In the present exemplary embodiment, a thickness of the dielectric film was about 10 μm.

Then, the internal coil patterns may be formed on the insulating sheets, as at 404.

The internal coil patterns may be formed by a pattern etching method.

Exposure and development may be performed using a dry film resist. After negative dry films are attached to opposite surfaces of the insulator sheet, the exposure and the development may be performed on the insulator sheet to which the negative dry films are attached, and a copper foil may be etched through portions in which the negative dry films are removed. In this case, the internal coil patterns may be formed at a width of about 15 μm. When the internal coil patterns are formed, via pads, using which the internal coil patterns and via conductors are connected to each other, may be formed together with the internal coil patterns. The via pads maybe formed at a size of about 50 μm.

The first metal used for the internal coil patterns may be or include, for example, palladium (Pd), aluminum (Al), nickel (Ni), titanium (Ti), gold (Au), copper (Cu), platinum (Pt), a combination thereof, and the like.

The internal coil patterns may form the internal coil parts 121 and 122 in a process of forming the multilayer body by stacking the insulating sheets as described below, and may include the first lead portions 121′ and the second lead portions 122′.

Then, the second metal having the electrical conductivity higher than that of the first metal constituting the internal coil patterns may be applied to surround the internal coil patterns, as at 406.

According to the exemplary embodiment, the second metal may be or include silver (Ag), and surround the internal coil patterns formed of the first metal including copper (Cu).

A method of applying the second metal having the electrical conductivity higher than that of the first metal to surround the internal coil patterns is not limited to any particular method. In an example, the method may include electroplating.

Then, as at 408, the multilayer body 110 including the internal coil parts 121 and 122 of which the first lead portions 121′ and the second lead portions 122′ are exposed to the bottom surface 107 of the multilayer body 110 and the surfaces 103 and 105 of the multilayer body 110 perpendicular to the stacked surface of the multilayer body 110 may be formed by stacking the insulating sheets on which the internal coil patterns are formed.

Vias may be formed in predetermined positions on each of the insulating layers on which the internal coil patterns are printed, and the internal coil patterns formed on each of the insulating layers may be electrically connected to each other through the vias to form a single coil structure.

The first lead portions 121′ and the second lead portions 122′ of the internal coil parts 121 and 122 formed as a single coil structure may be exposed to the bottom surface 107 of the multilayer body 110 and the surfaces 103 and 105 of the multilayer body 110.

The internal coil parts 121 and 122 may be formed in the direction perpendicular to the board mounting surface of the multilayer body 110.

As described above, the respective insulating layers on which the individually formed internal coil patterns are printed may be collectively stacked and compressed to manufacture the multilayer body 110 in which the coil patterns and the via conductors are disposed.

Then, as at 410, the first external electrode 131 and the second external electrode 132 connected to the first lead portions 121′ and the second lead portions 122′ of the internal coil parts 121 and 122, respectively, may be formed on the bottom surface 107 of the multilayer body 110 and the surfaces 103 and 105 of the multilayer body 110.

The first and second external electrodes 131 and 132 may be formed of a conductive paste including a metal having relatively higher electrical conductivity, such as a conductive paste including nickel (Ni), tin (Sn), alloys thereof, and the like.

Multilayer electronic components according to examples disclosed include second metal having electrical conductivity higher than that of a first metal constituting internal coil parts and disposed to surround the internal coil parts. The first metal may be or include copper (Cu), the second metal may be or include silver (Ag), and electroplating may be used in a method of forming the second metal.

In examples disclosed, materials of the insulating sheets were configured to be different from each other, and the insulating sheets were manufactured using an LCP film (example 1), were manufactured using an LCP film including an inorganic filler (example 2), or were manufactured using a film formed of a low dissipation factor (Df) epoxy-based insulating material (example 3).

In methods of manufacturing multilayer electronic components according to examples disclosed, a bump plating process, a mask process, matching/collective stacking processes, an external electrode forming process, and the like, were used.

A multilayer electronic component according to a comparative example was manufactured by a method of manufacturing a general high frequency inductor, solder resists (SRs) were laminated and exposed/developed unlike the insulating sheets, according to examples disclosed, and internal coil patterns constituting internal coil parts were formed by pattern fill plating using copper (Cu).

In examples disclosed, a material having high electrical conductivity may be coated to surround a coil on which a magnetic flux and a current are concentrated due to a skin effect and a parasitic effect, resulting in a reduction in an equivalent series resistance (Rs) as compared to Comparative Example.

Therefore, it may be appreciated that a quality (Q) factor is improved in the examples as compared to the comparative Example.

In addition, in examples disclosed, an insulating material having a low dielectric property may be used instead of an existing photosensitive material used in the comparative example to reduce the skin effect, resulting in improvement of electrical, mechanical, and thermal characteristics.

A description of features that are the same as those of the multilayer electronic component 100 according to the exemplary embodiment in the present disclosure described above will be omitted.

As set forth above, according to the exemplary embodiments in the present disclosure, the material having relatively higher electrical conductivity may be coated to surround the coil on which the magnetic flux and the current are concentrated due to the skin effect and the parasitic effect, resulting in the reduction in the equivalent series resistance (Rs).

Therefore, the multilayer electronic component 10 of which the quality (Q) factor is improved may be obtained.

In addition, the insulating material having the dielectric properties lower than that of the existing photosensitive material may be used to reduce the skin effect, resulting in the improvement of the electrical, mechanical, and thermal characteristics.

While exemplary embodiments have been shown and described above, it will be apparent to those skilled in the art that modifications and variations could be made without departing from the scope of the present invention as defined by the appended claims.

What is claimed is:

1. A multilayer electronic component, comprising:
a multilayer body including a plurality of insulating layers and internal coil parts disposed on the insulating layers, the plurality of insulating layers being stacked; and
external electrodes disposed on external surfaces of the multilayer body and connected to the internal coil parts,
wherein the internal coil parts include a first metal, and
a second metal having an electrical conductivity higher than that of a first metal is disposed on the internal coil parts and surrounds the internal coil parts.

2. The multilayer electronic component of claim 1, wherein the second metal includes silver (Ag).

3. The multilayer electronic component of claim 1, wherein the internal coil parts have first lead portions and second lead portions externally exposed.

4. The multilayer electronic component of claim 3, wherein the first lead portion and the second lead portion have an ‘L’ shape in a cross section of the multilayer body in a length-thickness direction.

5. The multilayer electronic component of claim 3, wherein the first lead portion and the second lead portion include the first metal.

6. The multilayer electronic component of claim 1, wherein the multilayer body further includes dummy lead portions disposed on the plurality of insulating layers and externally exposed.

7. The multilayer electronic component of claim 1, wherein the internal coil parts are disposed perpendicular to a board mounting surface of the multilayer body.

8. The multilayer electronic component of claim 1, wherein an insulating material included in the multilayer body includes a material having a dielectric property lower than that of a photosensitive material.

9. A method of manufacturing a multilayer electronic component, comprising:
preparing a plurality of insulating sheets;
forming internal coil patterns on the insulating sheets;
applying a first metal to surround the internal coil patterns, the first metal having electrical conductivity higher than that of a second metal included in the internal coil patterns;
forming a multilayer body including internal coil parts by stacking the insulating sheets on which the internal coil patterns are formed; and
forming external electrodes on external surfaces of the multilayer body, the external electrodes being connected to the internal coil parts.

10. The method of claim 9, wherein the first metal includes silver (Ag).

11. The method of claim 9, wherein the internal coil parts have first lead portions and second lead portions externally exposed.

12. The method of claim 11, wherein the first lead portion and the second lead portion have an ‘L’ shape in a cross section of the multilayer body in a length-thickness direction.

13. The method of claim 11, wherein the first lead portion and the second lead portion include the second metal.

14. The method of claim 9, further comprising forming dummy lead portion patterns on the insulating sheets,
wherein the multilayer body includes stacking the insulating sheets having the dummy lead portion patterns formed thereon stacked adjacent to each of first lead portions and second lead portions and exposed to a surface of the multilayer body perpendicular to a stacked surface of the multilayer body.

15. The method of claim 9, further comprising disposing the first metal using a plating or printing process.

16. The method of claim 9, wherein an insulating material included in the multilayer body includes a material having a dielectric property lower than that of a photosensitive material.
